(19) United States
(12) Patent Application Publication
(10) Pub. No.: US 2008/0301989 A1
(43) Pub. Date: Dec. 11, 2008

(54) FRAME FOR A FLEXIBLE BANNER AND FRAME AND FLEXIBLE BANNER ASSEMBLY

(76) Inventor: Paul J. Britten, Traverse City, MI (US)

Correspondence Address: HARNESS, DICKEY & PIERCE, P.L.C., P.O. BOX 828, BLOOMFIELD HILLS, MI, 48303, US

(21) Appl. No.: 12/106,715

(22) Filed: Apr. 21, 2008

Related U.S. Application Data
(60) Provisional application No. 60/913,308, filed on Apr. 23, 2007.

(51) Int. Cl. G09F 7/18

(52) U.S. Cl. 40/611.11

(57) ABSTRACT

A frame for holding a flexible banner in tension, and a frame and flexible banner assembly in which the flexible banner is held in tension, has a frame including segments that are positioned together to define an enclosed area. Each segment has two main parts that are held together with a hinge that runs along the entire length of the outer edge of the segment. One main part is a base and the other one serves as a decorative cover. To keep the covers closed, each segment has a number of springs that secured to both the base and cover. To load the frame with a banner, each cover can be opened by hand a device inside the frame can be used to hold the covers open. Once loaded, the banner is held in place and tensioned with banner tensions, which may be springs that stretch from posts in the frame to holes in the banner. One end of a spring is secured to the post and the other end of the spring is secured to the banner such as by an end of the spring extending through the hole in the banner and “hooking” the banner. The holding devices are then moved to allow the covers to spring shut. A frame and flexible banner assembly includes the foregoing frame and flexible banner.

### CROSS-REFERENCE TO RELATED APPLICATIONS

This application claims the benefit of U.S. Provisional Application No. 60/913,308 filed on Apr. 23, 2007. The disclosure of the above applications is incorporated herein by reference.

### FIELD

The present disclosure relates to banners, more particularly, to a frame for holding a flexible banner.

### BACKGROUND

The statements in this section merely provide background information related to the present disclosure and may not constitute prior art.

Banners are used to display content, such as advertising. Banners are typically made of a flexible material, such as fabric, paper, or a polymer such as nylon. In displaying banners, particularly larger banners such as often used for advertising, it is desirable to keep the banner smooth and free from wrinkles and the like.

### SUMMARY

A frame for a flexible banner includes a plurality of segments positioned together that define an enclosed area. Each segment has a plurality of banner tensioners spaced along it that are securable to the flexible banner to hold the flexible banner in tension in at least X and Y directions. In an aspect, each segment includes a base and a cover hinged together.

In an aspect, each segment includes a closure spring extending between its cover and base that urges the cover closed. In an aspect, each segment includes a hold-open device that can be used to hold the cover of the segment open.

In an aspect, the banner tensioners are springs (referred to as “banner tensioning springs”) each having an end secured to the base of the segment having that banner tensioning spring with the other end securable to the flexible banner. In an aspect, at least one banner tensioning spring extends through a hold down member secured to the base of the segment having that banner tensioning spring the other end of the banner tensioning spring securable to the flexible banner. In an aspect, the hold down members extend orthogonally across the bases of the segment having the hold down members. In an aspect, banner tensioning springs at ends of each segment extend across the base of that segment at an angle other than ninety degrees to a longitudinal axis of the base of that segment.

In an aspect, a frame and flexible banner assembly includes the foregoing frame and flexible banner.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a front perspective view of a frame holding a flexible banner in tension in accordance with an aspect of the present invention;

FIG. 2 is a front perspective view, partially broken away, of the frame of FIG. 1;

FIG. 3 is front perspective view of a corner of the frame of FIGS. 1 and 2 with covers of frame segments open:

FIG. 4 is a front perspective view of a portion of a frame segment of the frame of FIGS. 1 and 2 with the cover open;

FIG. 5 is a section view of a segment of the frame of FIGS. 1 and 2 with the cover in a closed position;

FIG. 6 is a section view of a segment of the frame of FIGS. 1 and 2 with the cover in an open position; and

FIG. 7 is perspective view of a banner tensioning spring of a segment of the frame of FIGS. 1 and 2.

### DETAILED DESCRIPTION

The following description is merely exemplary in nature and is not intended to limit the present disclosure, application, or uses. It should be understood that throughout the drawings, corresponding reference numerals indicate like or corresponding parts and features.

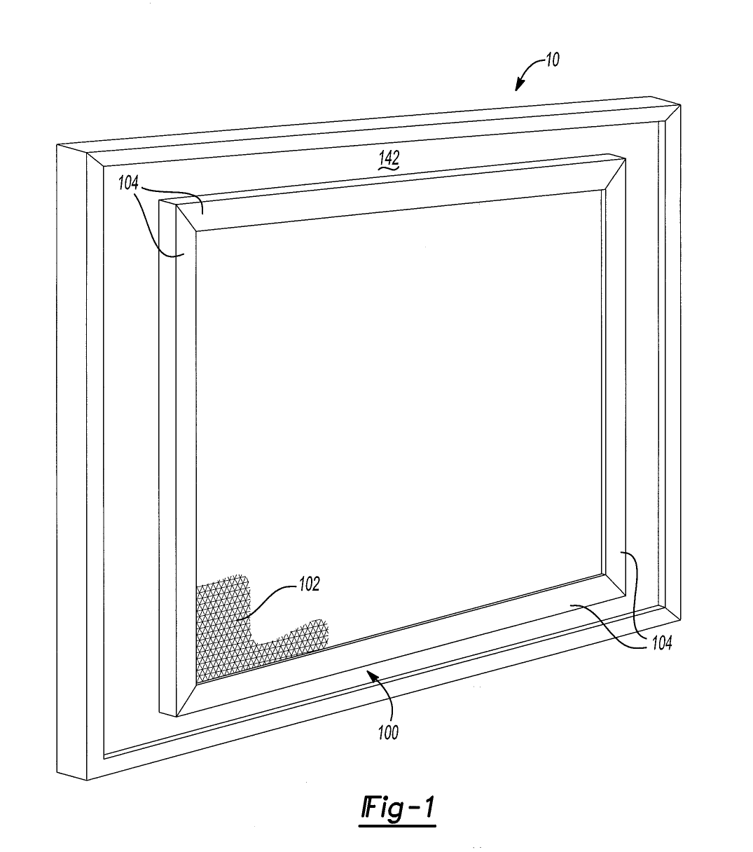

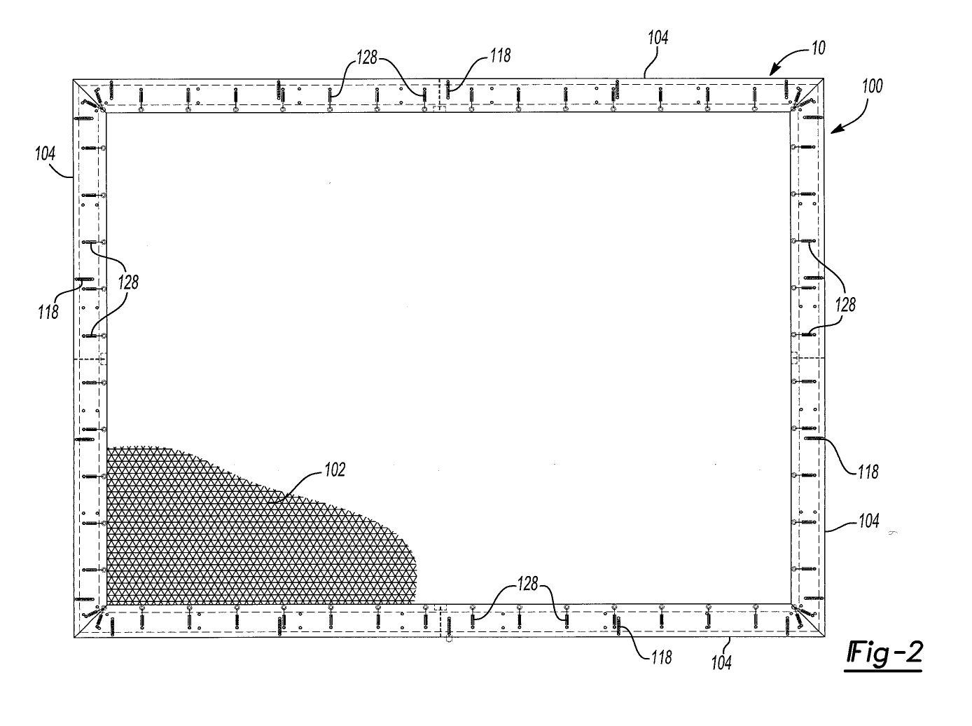

With reference to FIGS. 1 and 2, a frame 100 in accordance with an aspect of the present disclosure that holds a flexible banner 102 in tension is described. In an aspect, frame 100 holds flexible banner 102 in tension in both the X (horizontal) and Y (vertical) directions (as oriented in the drawings). As used herein, a flexible banner is a banner made of flexible material such as fabric, paper, or a polymer such as nylon. A frame and flexible banner assembly 10 includes frame 100 and flexible banner 102.

In an aspect, frame 100 has a modular design utilizing three or more frame segments that are positioned together and define an enclosed area. The segments are manufactured individually in various sizes such that they can be mixed and matched and then mounted to a flat surface to create many different shapes and sizes. As discussed in more detail below, each segment has two main parts that are held together with a hinge that runs along the entire length of the outer edge of the segment. One main part has screw holes through it and the other one serves as a decorative cover. To keep the covers closed, each segment has a number of springs that secured to both main parts.

To load the frame with a banner, each cover can be opened by hand and a device inside the frame can be used to hold the covers open. Once loaded, the banner is held in place and tensioned with springs that stretch from posts in the frame to holes in the banner. One end of a spring is secured to the post and the other end of the spring is secured to the banner such as by an end of the spring extending through the hole in the banner and “hooking” the banner. The holding devices are then moved to allow the covers to spring shut.

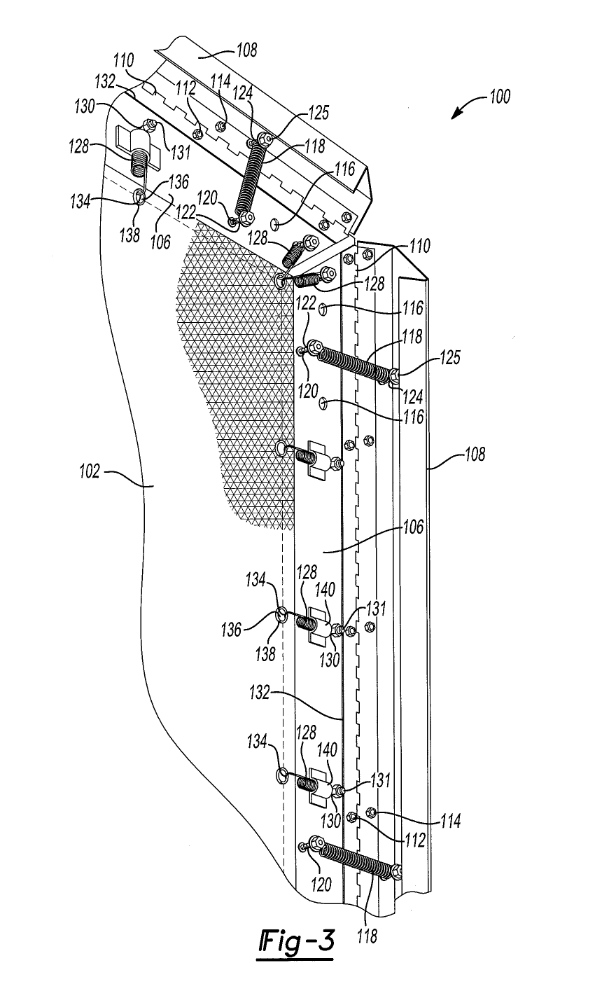

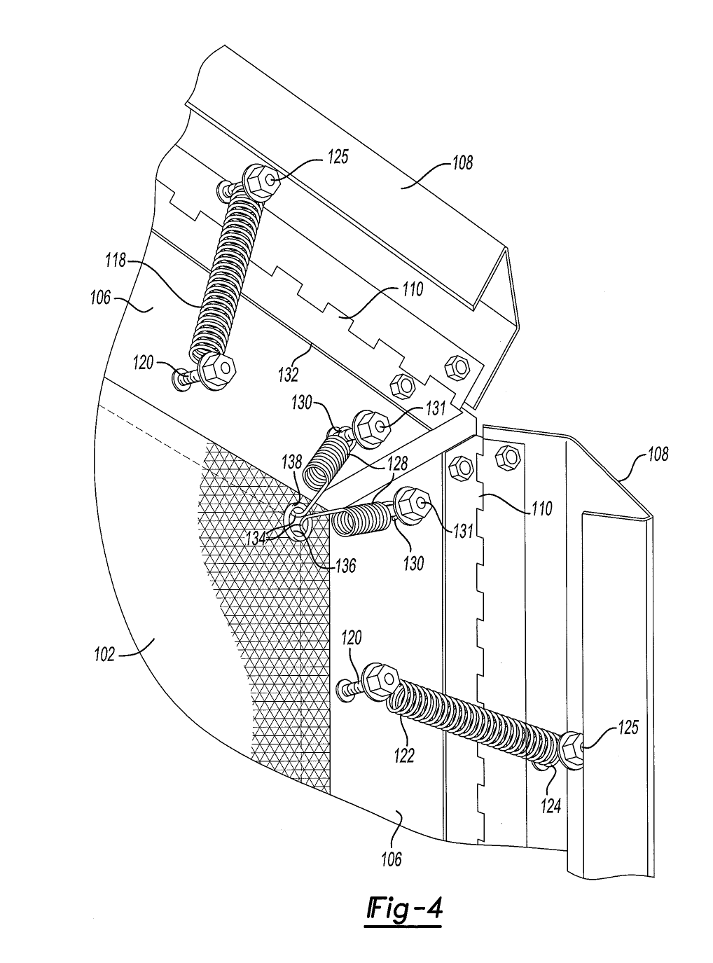

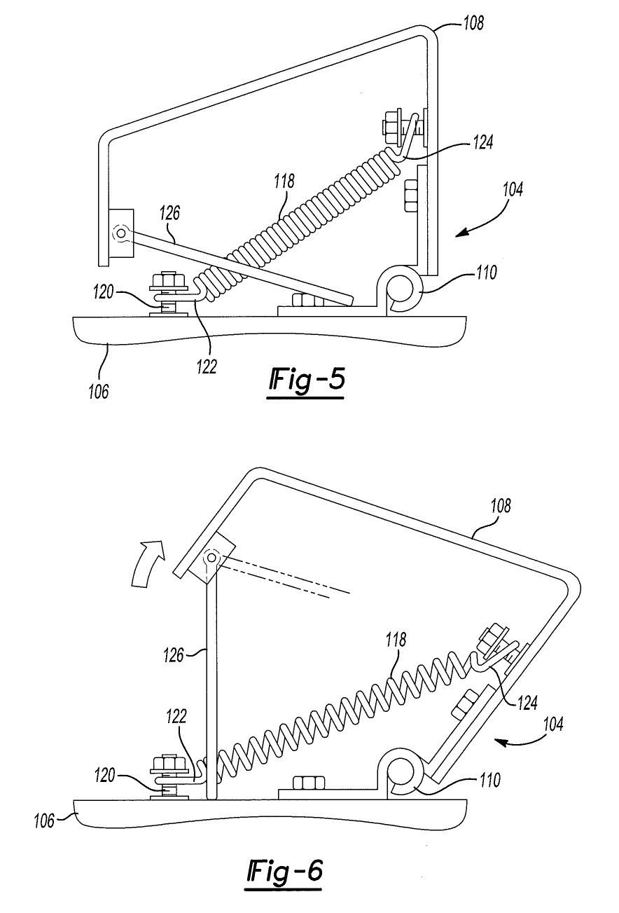

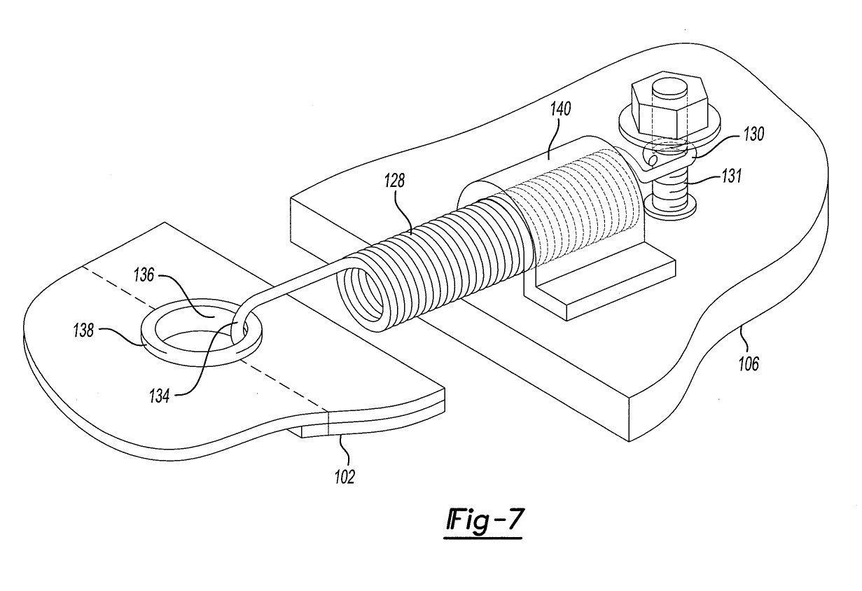

In the embodiment shown in FIGS. 1 and 2, frame 100 includes four segments 104 (a top segment, a bottom segment, and two opposed side segments). In this embodiment, each segment 104 is a linearly extending segment. Each segment 104 includes two main parts, a base 106 and a cover 108 that are joined together by a longitudinally extending hinge 110 (as best shown in FIGS. 3 and 4). Hinge 110 may be secured to base 106 by nuts and bolts 112 and to cover 108 by nuts and bolts 114. It should be understood that hinge 110 may be secured to base 106 and cover 108 by other fastening methods, such as by welding. Base 106 includes screw holes 116.

Each segment 104 includes a plurality of springs 118 (referred to herein as “closure springs 118”) that extend between base 106 of that segment 104 and the inside of the cover 108 of that segment 104. In an aspect, base 106 includes upwardly extending posts 120. One end 122 of each closure spring 118 is secured to one of posts 120 and the other end 124 of the closure spring 118 is secured to the inside of the cover 108. Cover 108 may have similar posts 125 to which the other end 125 of the closure springs are secured. When cover 108 of a segment 104 is rotated open, its closure springs 118 are tensioned. When cover 108 is released, closure springs 118 urge cover 108 closed. In this regard, closure springs 118 may illustratively remain tensioned to some degree when cover 108 is closed to keep cover 108 in a closed position.

Each segment 104 illustratively includes a device that can be used to hold its cover 108 open, referred to herein as a “hold-open device.” In an aspect, this device includes a rod 126 (FIG. 4). Rod 126 may be hingedly secured at one end to cover 108 or at its other end to base 106. When cover 108 is opened, rod 126 is positioned so that it extends between cover 108 and base 106 and holds cover 108 in an open position. When it is desired to close cover 108, rod 126 is repositioned so that it no longer extends between cover 108 and base 106, releasing cover 108 to close.

Each segment 104 includes a plurality of banner tensioners spaced along it. In an aspect, the banner tensioners are springs, referred to herein as banner tensioning springs 128. It should be understood that banner tensioners can be devices other than springs, such as elastic members.

In an aspect, each banner tensioning spring 128 is secured at one end 130 to base 106 of that segment 104. In an aspect, base 106 includes an upwardly extending post 131 for each banner tensioning spring 128, which in an aspect are toward at an outer edge 132 (FIGS. 3 and 4) of base 106, to which the end 130 of a banner tensioning spring 128 is secured. The other end 134 of each banner tensioning spring 128 is secured to flexible banner 102. Illustratively, end 134 of banner tensioning spring 128 is hook shaped and is hooked through a hole 136 in flexible banner 102. A grommet 138 may illustratively surround each hole 136. In an aspect, one or more of the banner tensioning springs 128 extends through a respective hold down member 140 secured to base 106.

In the embodiment shown, the hold down members 140 of each segment 104 extend orthogonally across the base 106 of that segment 104 as do the banner tensioning springs 128 that extend through those hold down members 140. Also in the embodiment shown, the banner tensioning springs 128 at the ends of segments 104 extend other than orthogonally across the bases 106 of segments 104. That is, the banner tensioning springs 128 at the ends of segments 104 extend at an angle other than ninety degrees to a respective longitudinal axis of the respective base 106, such as thirty or forty-five degrees by way of example and not of limitation. It should be understood that banner tensioning springs 128 at locations other than at ends of segments 104 could also be angled in a similar manner. By angling the banner tensioning springs 128 in this manner, tension is exerted on the flexible banner 102 in directions that are at angles to the X and Y directions.

When frame 100 is assembled, each segment 104 is positioned in place on a flat surface 142 (FIG. 1), such as a side of a structure, so that the segments 104 define an area bounded on each side by at least one of the segments 104. The segments 104 are secured to the flat surface 142 by screws (not shown) that are threaded into the flat surface 142 through screw holes 116. It should be understood that fasteners other than screws can be used to secure segments 104 to the flat surface 142.

After frame segments 104 are secured to the flat surface 142, covers 108 of the segments 104 are opened. As discussed, covers 108 may be held in the open position by the hold open devices, which in an embodiment are rods 126. Flexible banner 102 is then placed in frame 100 and ends 134 of banner tensioning springs 128 hooked in holes 136 of flexible banner 102 to secure flexible banner 102 to frame 100. Covers 108 are then closed.

Banner tensioning springs 128 hold flexible banner 102 in tension. By tensioning flexible banner 102 in this manner, flexible banner 102 is maintained smooth and unwrinkled. Further, banner tensioning springs 128 will continue to exert tension on flexible banner 102 as it may stretch over time and maintain the tensioned holding of flexible banner 102.

What is claimed is:

1. A frame for a flexible banner, comprising;
a plurality of segments positioned together that define an enclosed area;
each segment having a plurality of banner tensioners spaced along it; and
the banner tensioners securable to the flexible banner to hold the flexible banner in tension in at least X and Y directions.

2. The apparatus of claim 1 wherein each segment includes a base and a cover hinged together.

3. The apparatus of claim 2 wherein each segment includes a closure spring extending between its cover and base that urges the cover closed.

4. The apparatus of claim 3 wherein each segment includes a hold-open device that can be used to hold the cover of the segment open.

5. The apparatus of claim 1 wherein the banner tensioners are banner tensioning springs each having an end secured to the base of the segment having that banner tensioning spring the other end securable to the flexible banner.

6. The apparatus of claim 5 wherein at least one banner tensioning spring extends through a hold down member secured to the base of the segment having that banner tensioning spring, the other end of the banner tensioning spring securable to the flexible banner.

7. The apparatus of claim 6 wherein the hold down members extend orthogonally across the bases of the segment having the hold down members.

8. The apparatus of claim 6 wherein banner tensioning springs at ends of each segment extend across the base of that segment at an angle other than ninety degrees to a longitudinal axis of the base of that segment.

9. The apparatus of claim 6 wherein each segment includes a base and a cover hinged together.

10. The apparatus of claim 10 wherein each segment includes a closure spring extending between its cover and base that urges the cover closed.

11. The apparatus of claim 11 wherein each segment includes a hold-open device that can be used to hold the cover of the segment open.

12. A frame and flexible banner assembly, comprising;
a frame, the frame having a plurality of segments positioned together to define an enclosed area with each segment having a plurality of banner tensioners spaced along it; and
a flexible banner secured to the banner tensioners, the banner tensioners holding the flexible banner in tension in at least X and Y directions.

13. The assembly of claim 12 wherein each segment includes a base and a cover hinged together.

14. The assembly of claim 13 wherein each segment includes a closure spring extending between its cover and base that urges the cover closed.

15. The assembly of claim 14 wherein each segment includes a hold-open device that can be used to hold the cover of the segment open.

16. The assembly of claim 12 wherein the banner tensioners are banner tensioning springs each having an end secured to the base of the segment having that banner tensioning spring and its other end secured to the flexible banner.

17. The assembly of claim 16 wherein at least one banner tensioning spring extends through a hold down member secured to the base of the segment having that banner tensioning spring, the other end of the banner tensioning spring securable to the flexible banner.

18. The assembly of claim 17 wherein the hold down members extend orthogonally across the bases of the segment having the hold down members.

19. The assembly of claim 17 wherein banner tensioning springs at ends of each segment extend across the base of that segment at an angle other than ninety degrees to a longitudinal axis of the base of that segment.

20. The assembly of claim 16 wherein each segment includes a base and a cover hinged together.

21. The assembly of claim 17 wherein each segment includes a closure spring extending between its cover and base that urges the cover closed.

22. The assembly of claim 18 wherein each segment includes a hold-open device that can be used to hold the cover of the segment open.
